(19) United States
(12) Patent Application Publication
(10) Pub. No.: US 2016/0157280 A1
(43) Pub. Date: Jun. 2, 2016

(54) SIGNALLING REDUCTION FOR IP TRAFFIC IN WIRELESS NETWORKS

(71) Applicant: TELEFONAKTIEBOLAGET L M ERICSSON (PUBL), Stockholm (SE)

(72) Inventors: Victor Manuel AVILA GONZALEZ, Madrid (ES); Ulf MATTSSON, Kungsbacka (SE)

(73) Assignee: TELEFONAKTIEBOLAGET L M ERICSSON (PUBL), Stockholm (SE)

(21) Appl. No.: 14/786,782

(22) PCT Filed: Apr. 24, 2013
(86) PCT No.: PCT/EP2013/058503

§ 371 Date: Oct. 23, 2015

(51) Int. Cl. H04W 76/02; H04L 12/28; H04W 28/02

(52) U.S. Cl. CPC H04W 76/022; H04W 28/0263; H04L 12/2876; H04W 76/025

(57) ABSTRACT

Method and apparatuses are provided for setting up at least one dedicated bearer, DB, or at least a secondary PDP contexts, SPC, in a system comprising a terminal (1) a gateway (4) and an application server (6), for further transmitting internet protocol packets between at least the terminal and the gateway, the method comprising the steps—setting (202) up a default bearer or first PDP context between the terminal and the gateway;—providing (206; 208) a list of associations from the application server to the terminal, and—providing (209) a list of associations in or to the gateway, wherein each association comprises a service identity (m, n) and one or more applications (p; q);—starting (212) an application;—detecting (213, 217) at least one or more five-tuples, FT, associated with the application;—creating (214, 215; 216), in both the terminal (1) and the gateway (4), for the service identity associated with the stated application in question, a further association concerning at least the detected one or more FT;—setting (220, 220a) up a DB/SPC for the service identity between terminal and gate-way; and—binding (224; 226) in the terminal (1) and/or in the gateway (4), the FT further associated with the service identity to the DB/SPC.

### TECHNICAL FIELD

This invention is directed to the setting up and handling of resources relating to Internet

Protocol traffic over wireless networks. The invention is in particularly related to the setting up and handling of dedicated bearers in system architecture evolution, SAE/evolved packet core, EPC, networks and secondary packet data protocol contexts for general packet radio services, GPRS, networks.

### BACKGROUND

Dedicated bearers for SAE or network initiated secondary Packet Data Protocol, PDP, context for GPRS constitute a standardized mechanism to provide a differentiated quality of service, QoS, for a certain part of the traffic within a Packet Data Network, PDN, connection. This mechanism requires that the packet gateway, PGW/Gateway GPRS Support Node, GGSN, signals to the terminal, the Traffic Flow Template's, TFT's that characterizes the traffic that run through the dedicated bearer/secondary PDP. A TFT comprises a set of 5-tuples (Origin/destination IP address, Origin/destination port and protocol) (5-tuples will in the following be abbreviated five-tuples, FT) that represent an IP flow and some additional parameters. If it is intended to deliver a service through a dedicated bearer/secondary PDP, then the PGW needs to send to the terminal, at dedicated bearer/secondary PDP context set-up, with as many TFTs as IP flows that such service has opened. For every new IP flow created/removed, the PGW shall send the added/removed TFT to the terminal. The PGW is responsible for DL traffic binding, while the UE is responsible for UL traffic binding.

In the SAE architecture the dedicated bearer is opened upon request from the PGW.

In a GPRS system, the network initiated secondary PDPs are opened by the terminal upon receiving a request from the GGSN. In GPRS, the terminal needs to request the secondary PDP activation upon receiving the “Request Secondary PDP Context Activation” message from GGSN and once the PDP context is activated do the UL binding.

In FIG. 1, a scenario for setting up and using a dedicated bearer in the context of an EPC network for a user using an application (or service) is shown. Such service could for instance be an application or other the top, OTT, service, commonly abbreviated as APP, such as YouTube™, Facebook™ or Gmail™.

OTT services usually open many IP flows and these changes along the service delivery. One example is YouTube. E.g. when an application, such as YouTube application, is started, up to 20-30 different IP flows might be opened. When the user scrolls down for new videos, even more IP flows are opened up. The PGW needs to signal each and every new IP flow that is created/modified or removed.

Some steps of the known procedure shall be explained in the following:

Before any internet service is commenced, a default bearer is established 101 between the terminal, TM and the gateway, GW.

When a service or application shall use a different QoS compared to the Default bearer, a dedicated bearer is set-up. The service or application may have many IP streams which need to be mapped onto the dedicated bearer via TFTs.

A first TFT, TFT_0 is therefore established by means of a dedicated bearer. The gateway issues a Create Bearer Request signal including one of the TFT's which can be selected. Subsequently, binding is performed for channelling the IP stream on a given bearer. The binding may concern the default bearer or on any of a plurality of dedicated bearers. It is noted that each bearer may have a specific QoS. The terminal performs uplink, UL, binding 104, while the gateway performs downlink, DL, binding 105.

Depending on the application, a number of TFT' (TFT_1 . . . TFT_q) are conveyed, all by means of respective modify bearer request signals (107, 111). Subsequent binding is also performed for each IP flow, 108, 109, 112 and 113.

One problem, identified according to the invention, is that the existing mechanisms involve a substantial signalling overhead.

### SUMMARY

It is a first object of the invention to decrease the setting of resources relating to conveying Internet Protocol traffic over wireless networks.

This object has been accomplished by a method for setting up at least one dedicated bearer, DB, or at least a secondary PDP context, SPC, in a system comprising a terminal a gateway and an application server, for further transmitting internet protocol packets between at least the terminal and the gateway, the method comprising the steps
setting up a default bearer or first PDP context between the terminal and the gateway;
providing a list of associations from the application server to the terminal, and—providing a list of associations in or to the gateway, wherein each association comprises a service identity and one or more applications;
starting an application;
detecting at least one or more five-tuples, FT, associated with the application;
creating, in both the terminal and the gateway, for the service identity associated with the stated application in question, a further association concerning at least the detected one or more FT;
setting up a DB/SPC for the service identity between terminal and gateway;
binding in the terminal and/or in the gateway, the FT further associated with the service identity to the DB/SPC.

According to a further aspect, there is provided a method for a terminal for assisting setting up at least one dedicated bearer, DB, or at least one secondary PDP context, SPC, the terminal (interacting with a gateway and an application server, and for transmitting internet protocol packets between at least the terminal and the gateway, the method comprising the steps
receiving and storing a list of associations from the application server, wherein each association comprises a service identity and one or more applications, for instance upon transmitting a get list signal to the application server;
starting an application,
detecting at least one FT associated with the started application; or receive information concerning at least one FT associated with the started application and the service identity associated with the application;
creating, for the service identity associated with the application in question, a further association concerning the at least one detected FT;
setting up a DB/SPC for the service identity between terminal and gateway;
binding, the at least one FT further associated with the service identity to the dedicated bearer.

The above object has moreover been accomplished by Method for a gateway for setting up at least one dedicated bearer, DB, or at least one secondary PDP context, SPC, the gateway interacting with a terminal and an application server, and for transmitting internet protocol packets between at least the terminal and the gate-way, the method comprising the steps
providing a list of associations in or to the gateway, wherein each association comprises a service identity and one or more applications;
setting up a default bearer or first PDP context between the terminal and the gateway;
detecting at least one FT associated with the started application; or receiving information concerning at least one FT associated with the started application and the service identity associated with the application;
creating, in the gateway, for the service identity associated with the started application in question, a further association concerning at least the detected one or more FT's;
setting up a DB/SPC for the service identity between terminal and gateway;
binding in the gateway, the FT further associated with the service identity to the DB/SPC.

Still further, the above object has been accomplished by a method for an application server, for assisting setting up at least one dedicated bearer, DB, or at least one secondary PDP context, SPC, the application server interacting with a terminal and a gateway, for transmitting internet protocol packets between one another. The method comprising the steps
transmitting a list of associations from the application server, wherein each association comprises a service identity (m, n) and one or more applications;
providing a list of associations from the application server to the terminal.

Corresponding to the methods a terminal, a gateway and an application server is provided to attain the above object.

In order to run services with a differentiated QoS, the network needs to know which IP Flows belong to this service delivery. In the prior art, this appeared to be quite challenging as many services are not under the control of the operator and the services might open tens of different IP flows and in a very dynamic way. Aspects of the present invention handle services with differentiated QoS in a signalling efficient manner.

This further object is accomplished by a method—provisioning a list of policies in the gateway, whereby each service identity is assigned a given policy;
applying the policy for the service identity of the application being started according to the provisioning;
transmitting a create bearer request signal comprising at least the service identity from the gateway to the terminal for setting up the DB/SPC.

### BRIEF DESCRIPTION OF THE DRAWINGS

FIG. 1 shows a prior art EPC network and signalling associated with an internet session in which an application is used,

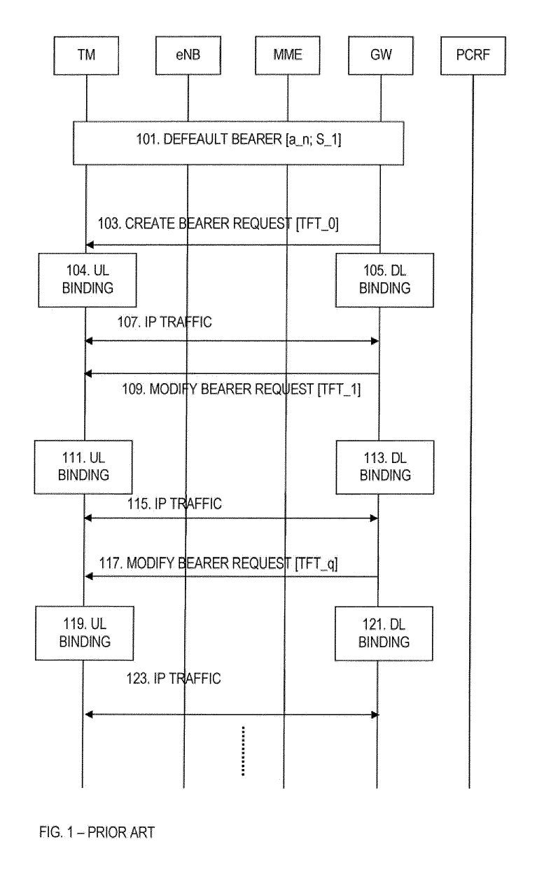

FIG. 2 shows a data structure according to an embodiment of the invention,

FIG. 3 shows an embodiment of the invention in which signalling and setting up of dedicated bearer/secondary PDP context,

FIG. 4 shows two further embodiments for implementing details of the FIG. 3 method,

FIG. 5 shows another embodiment for implementing details of the FIG. 3 method, and

FIG. 6 shows an exemplary terminal, exemplary gateway and exemplary server according to the invention,

FIG. 7 shows an alternative implementation the terminal according to the invention,

FIG. 8 shows an alternative implementation the gateway according to the invention, and

FIG. 8 shows an alternative implementation the application server according to the invention.

### DETAILED DESCRIPTION

According to an aspect of the invention, the binding between traffic that needs a specific dedicated bearer/secondary PDP context is based on a data structure according to the invention, denoted service identification, service ID.

Some existing mechanisms to set up dedicated bearers/secondary PDP contexts are used in embodiments of the invention. According to some aspects of the invention, the PGW/GGSN binds the downlink, DL, traffic while the terminal binds the up-link, UL, traffic.

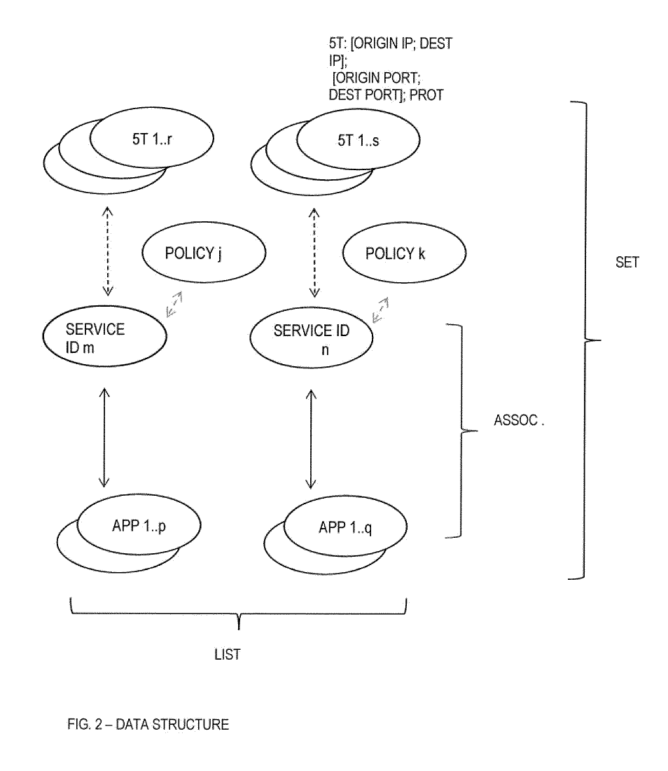

In FIG. 2, a further data structure according to the invention is shown. According to the invention, the so-called service identification, service ID, m, is associated with at least one application, 1-p, APP. Such an application could be for instance be any one of those mobile software applications which may be offered under e.g. the Android operating system of Google—Google Play, the loS operating system of Apple, App store, or the Windows Phone Store for the Windows operating system. Such applications may also be referred to as an over the top, OTT, service, which typically are not under the control of the operator who operates the mobile network (including the gateway). Many of these applications contain numerous internet links adapted for streaming various internet streams. It is noted that the number of applications currently offered by some of the above application vendors ranges in hundreds of thousands. It also noted that some applications are widely used.

According to the invention, each service ID is moreover adapted to be associated with a plurality, 1-r, Traffic Flow Templates TFTs. As mentioned above, a TFT comprises a set of 5-tuples, FT, comprising origin/destination IP address, origin/destination port and protocol. In other words each service ID is further associated with a FT. One could also say that the association of a given service ID and one or more applications is extended into a set also comprising one or more FT's.

As understood, from FIG. 2, multiple service ID's, and hence multiple associations and sets exist.

Typical applications may relate to the same QoS class. According to the invention, the bundling of applications to one particular service ID, as shown in FIG. 2, could advantageously concern such applications, e.g. social networking and messaging, having the same QoS requirements. As will be explained in the following, the service ID may be associated with a given policy defining e.g. a given QoS.

According to one embodiment of the invention, the gateway is adapted to provide data streams concerning a large variety of applications or services to terminals. According to the invention, both the terminal and the gateway is provided to have identical information concerning service ID's or at least a plurality of identically defined service ID's, whereby each service ID is associated with a specific combination of applications and FT's in a manner as shown in FIG. 2.

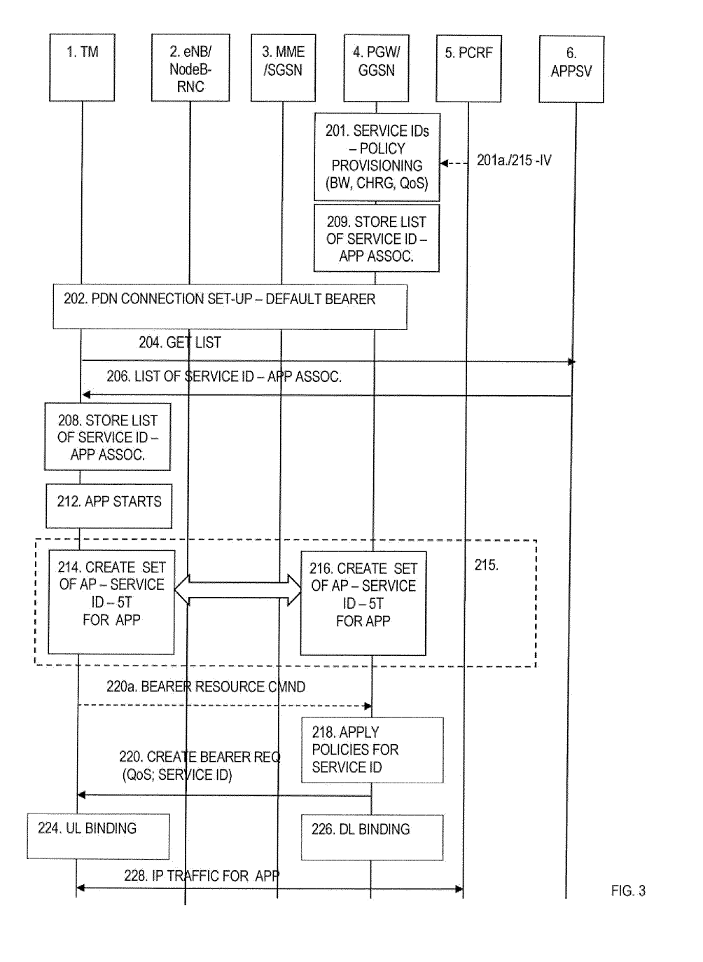

In FIG. 3, an embodiment of the invention is shown. This embodiment concerns an EPC network comprising a terminal, TM, 1, a base station denoted eNode B, 2, a mobility management entity, MME, 3, a gateway, GW, e.g. Packet Gateway, PGW, 4, a Policy Control Rule Function, PCRF, 5 and an EAP server, 6.

For the GPRS application according to the invention, node 2 corresponds to a combination of NodeB and radio network controller, RNC. The MME's functionality corresponds partly a Serving GPRS Support Node, 3. The gateway corresponds to a Gateway GPRS Support Node.

In FIG. 3 is shown a method for setting up at least one dedicated bearer, DB, or secondary PDP context, SPC, in a system comprising a terminal 1 a gateway 4 and an application server 6, for further transmitting internet protocol packets between at least the terminal and the gateway, the method comprising the steps

In step 201, a list of service identities is provisioned to/in the gateway, whereby each service identity is assigned a given policy. This step could be undertaken as a manual configuration of the gateway. The policy may concern bandwidth, charging and quality of service.

Moreover, in step 209, a list of associations is provided in or to the gateway, wherein each association comprises a service identity m, n and one or more applications p; q.

Steps 201 and 209 may be performed by manual configuration.

In step 202, up a default bearer or first PDP context between the terminal and the gateway constituting a PDN connection is set up.

In step 204, the terminal transmits a signal requesting a list of associations as defined in connection with FIG. 2. Consequently, the application server, 6, is providing 206; 208 a list of associations to the terminal and the gateway wherein each association comprises a service identity m, n and one or more applications 1..p; 1..q. The terminal stores this information, 208. It is noted that the information of step 208 corresponds to the information of step 209 above.

In step 212 the terminal or the user of the terminal is starting 212 an application.

According to step 215—encompassing at least steps 214 and 216—at least one or more five-tuples, FT, associated with the application—is detected 213, 217.

In steps 214 and 216, in both the terminal 1 and the gateway 4, there is created, for the service identity associated with the stated application in question, a further association concerning at least the detected one or more FT; in other words a given association is expanded into a set also comprising at least a FT further associated with application associated with the service ID.

In step, 218, the gateway is applying the policy for the service identity of the application being started according to the provisioning 210. A policy decision could involve the setting up of a dedicated bearer.

Subsequently, in step 220, the gateway is transmitting a Create Bearer Request signal, according to the EPC application, comprising at least the service identity from the gateway to the terminal for setting up the DB/SPC. The Create Bearer Request signal is known in the art, but according to some embodiments of the invention it may comprise new information elements. The create bearer request signal 220 may moreover comprise a quality of service defined according a policy for which the service identity is assigned in the provisioning done in step 201.

The dedicated bearer may, instead of being initiated by the network, also be initiated by the terminal. If that is the case, again for the EPC case, the terminal issues a Bearer Resource Command, 220a, whereupon the apply policy and the Create Bearer Request signal 220 follows.

For a GPRS application in which secondary PDP contexts are set up, similar signalling denoted Create PDP Context Request—for the terminal initiated procedure—and Initiate PDP Context Activation Request, for the network initiated procedure are used, instead of the signals 220a/ 20.

Now, the FT further associated with the service identity are bound to the DB/SPC 224; 226, in the terminal 1 and/or in the gateway 4 on the up-link and/or on the downlink, respectively.

IP traffic can now flow, step, 228 in the dedicated bearer/secondary PDP context, between the terminal 1 and the gateway 4, for the FT's without virtually any further signalling being needed. In particular, no modify bearer request signalling need to be conveyed, because the FT's are known to the terminal and the gateway for the application in question.

According to a further aspect of the invention, a policy is assigned for a given the service ID. For instance a given QoS pertains to the dedicated bearer. In case of several QoS classes, a dedicated bearer may be established for each policy and hence service ID.

According to the invention, there is provided for the possibility off an operator being able to appropriately bundle together various applications to one service ID. Hence, for instance social applications could be bundled together with one service ID.

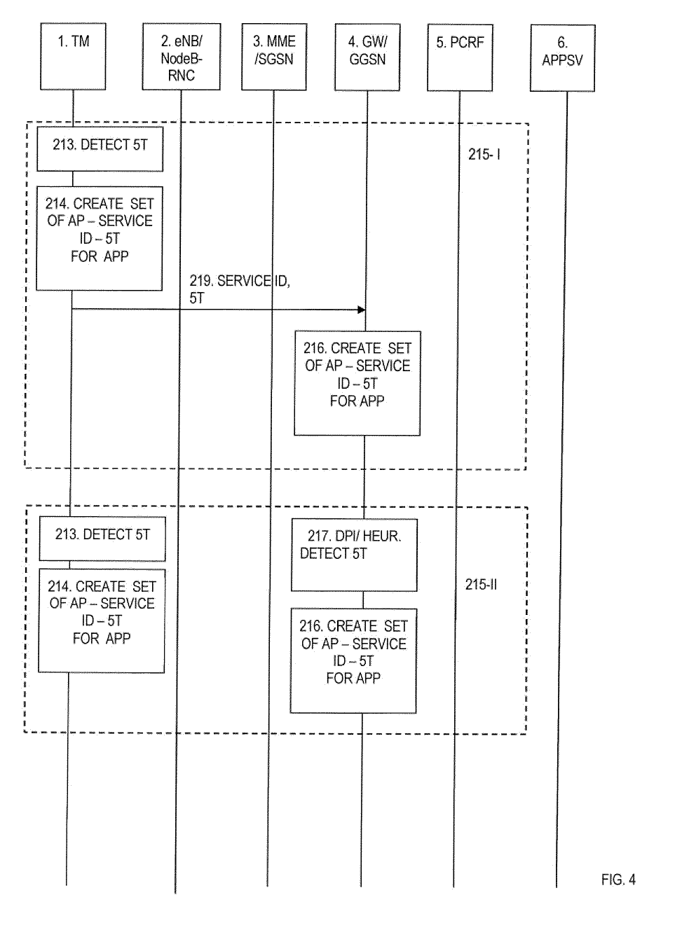

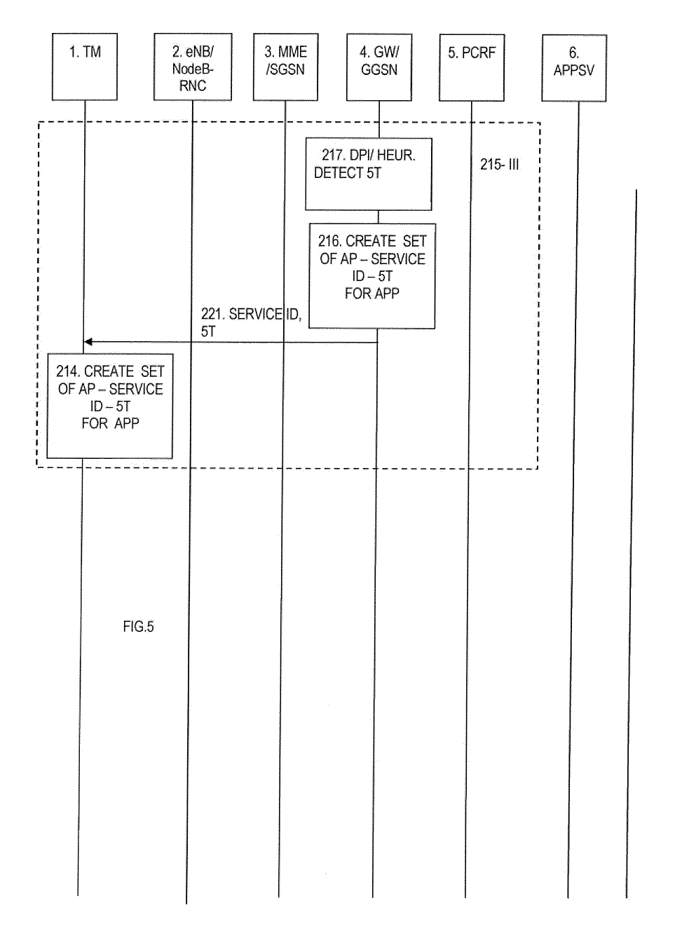

In FIGS. 4 and 5, various embodiments 215-I, 215-II, and 215-III for implementing step 215 of FIG. 3 are shown.

In 215-I, after having started the application 212, the terminal detects in step 213 the FT associated with the application and then creates the set of applications, service ID and FT's for the application, 214.

Subsequently, the terminal transmits step 219 a signal to the gateway comprising the service identity and the FT for the started application. Now the gateway creates for the service ID in question the same set of service ID, FT for the given application. Since the association of service ID and applications was provided previously to the gateway, step 209, the gateway can expand the association into a set upon being provided with the information in signal transmitted under step 219.

According to another embodiment, 215-II, the detection is carried out both in the terminal and in the gateway. The gateway is detecting 215, 217 the at least one FT associated with the started application. Deep packet inspection or heuristic routines, known in the art, are applied for the detection. In this case there is no need to transfer any signaling according to step 219/221.

In a still further embodiment, 215-111, the gateway detects the at least one FT associated with the started application, by applying deep packet inspection or heuristic routines. Subsequently, the gateway transmits the at least one FT associated with the service ID, 221 to the terminal. Subsequently, the terminal creates the set, 214.

In other words there is provided a method for setting up at least one dedicated bearer, DB, or at least a secondary PDP contexts, SPC, in a system comprising a terminal 1 a gateway 4 and an application server 6, for further transmitting internet protocol packets between at least the terminal and the gateway, the method comprising the steps
setting 202 up a default bearer or first PDP context between the terminal and the gateway;
providing 206; 208 a list of associations from the application server to the terminal, and
providing 209 a list of associations in or to the gateway, wherein each association comprises a service identity m, n and one or more applications p; q;
starting 212 an application;
detecting 213, 217 at least one or more five-tuples, FT, associated with the application;
creating 214, 215; 216, in both the terminal 1 and the gateway 4, for the service identity associated with the stated application in question, a further association concerning at least the detected one or more FT;
setting 220, 220a up a DB/SPC for the service identity between terminal and gateway;
binding 224; 226 in the terminal 1 and/or in the gateway 4, the FT further associated with the service identity to the DB/SPC.

The Method may moreover comprise the steps of
provisioning 201 a list of policies in the gateway, whereby each service identity is assigned a given policy;
applying 218 the policy for the service identity of the application being started according to the provisioning 210;
transmitting 220 a create bearer request signal comprising at least the service identity from the gateway to the terminal for setting up the DB/SPC.

The create bearer request signal 220 may moreover comprises a quality of service defined according to a policy the service identity assigned in the provisioning.

There is also provided a method for a terminal 1 for assisting setting up at least one dedicated bearer, DB, or at least one secondary PDP context, SPC, the terminal 1 interacting with a gateway 4 and an application server 6, and for transmitting internet protocol packets between at least the terminal and the gateway 4, the method comprising the steps
receiving 206 and storing 208 a list of associations from the application server, wherein each association comprises a service identity m, n and one or more applications p; q, for instance upon transmitting 204 a get list signal to the application server;
starting 212 an application,
detecting 213 at least one FT associated with the started application; or receive information 221 concerning at least one FT associated with the started application and the service identity associated with the application;
creating 215-I, -II, -III; 214; 216, for the service identity associated with the application in question, a further association concerning the at least one detected FT;
setting 220 up a DB/SPC for the service identity between terminal and gateway;
binding 224, the at least one FT further associated with the service identity to the dedicated bearer.

The method may further comprise the steps of
transmitting 219 a message to the gateway or receiving 221 a message from the gateway comprising the service identity and the at least one detected FT associated with the application.

The Method for the terminal may comprise the step of the terminal detecting the at least one FT associated with the started application.

There is also provided a Method for a gateway 4 for setting up at least one dedicated bearer, DB, or at least one secondary PDP context, SPC, the gateway 4 interacting with a terminal 1 and an application server 6, and for transmitting internet protocol packets between at least the terminal and the gate-way, the method comprising the steps
providing 209 a list of associations in or to the gateway, wherein each association comprises a service identity m, n and one or more applications p; q;
setting 202 up a default bearer or first PDP context between the terminal and the gateway;
detecting 217 at least one FT associated with the started application; or receiving information 219 concerning at least one FT associated with the started application and the service identity associated with the application;
creating 216, in the gateway 4, for the service identity associated with the started application in question, a further association concerning at least the detected one or more FT's;
setting 220 up a DB/SPC for the service identity between terminal and gateway;
binding 226 in the gateway, the FT further associated with the service identity to the DB/SPC.

The Method for the gateway may moreover comprising the steps of the gateway
being provisioned 201 a list of policies, whereby each service identity is assigned a given policy;
applying 218 the policy for the service identity of the application being started according to the provisioning 210;
transmitting 220 a create bearer request signal comprising at least the service identity to the terminal for setting up the DB/SPC.

The Method for the gateway may comprise the steps of
transmitting 221 a message to the terminal or receiving 219 a message from the terminal comprising the service identity and the at least one detected FT associated with the application.

The Method for the gateway may, comprise the step of
detecting 215, 217 the at least one FT associated with the started application in the gateway, and wherein deep packet inspection or heuristic routines is applied for the detection.

Finally, there is provided a method for an application server 6, for assisting setting up at least one dedicated bearer, DB, or at least one secondary PDP context, SPC, the application server interacting with a terminal 1 and a gateway 4, for transmitting internet protocol packets between one another, the method comprising the steps
transmitting 206 a list of associations from the application server, wherein each association comprises a service identity m, n and one or more applications 1..p; 1..q;
providing 206; 208 a list of associations from the application server to the terminal.

The methods of the invention as described above may be implemented by means of a program or computer program product.

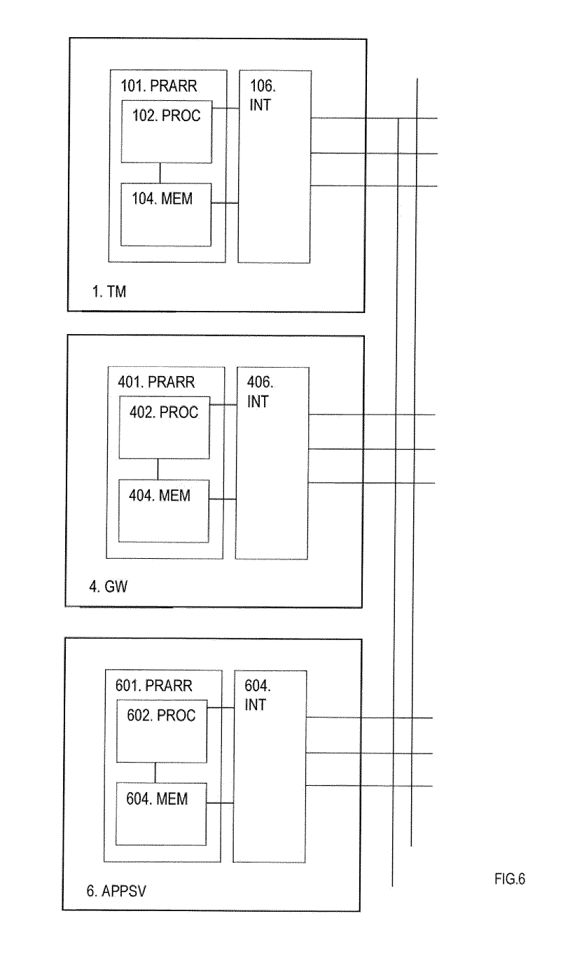

FIG. 6 shows a terminal 1, a gateway 4, and an application server, 6 according to the invention.

The terminal for implementing the invention may comprise a processing arrangement 101 and interface means 106 operative to assisting setting up assisting at least one dedicated bearer, DB, or at least one secondary PDP context, SPC, the terminal 1 interacting with a gateway 4 and an application server 6, and for transmitting internet protocol packets between at least the terminal and the gateway 4.

The processing arrangement 101 may comprise a processor 102 and a memory 104 and said memory is containing instructions executable by said processor.

The processing arrangement is operative to receive 206 and store 208 a list of associations from the application server, wherein each association comprises a service identity m, n and one or more applications p; q, for instance upon transmitting 204 a get list signal to the application server; start 212 an application, detect 213 at least one FT associated with the started application; or receive information 221 concerning at least one FT associated with the started application and the service identity associated with the application; create 215-I, -II, -III; -IV; 214; 216, for the service identity associated with the application in question, a further association concerning the at least one detected FT; set 220 up a DB/SPC for the service identity between terminal and gateway; bind 224, the at least one FT further associated with the service identity to the dedicated bearer.

The terminal is further being operative to transmit 219 a message to the gateway or receiving 221 a message from the gateway comprising the service identity and the at least one detected FT associated with the application.

The terminal may further be operative to detecting 215, 217 the at least one FT associated with the started application.

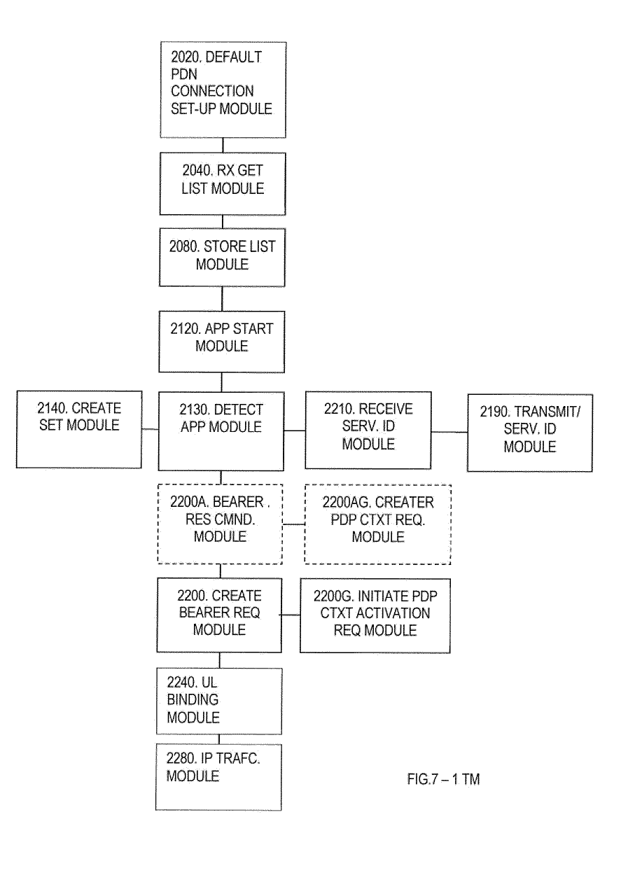

By alternative, the terminal may comprise, as shown in FIG. 7, a default PDN connection module 2020, carrying out step 202; a receive get list module 2040, carrying out 204;a store list module 2080, carrying out 208; an APP start module 2120, carrying out 212.

Moreover various modules are involved: a create set module 2140, operative to perform step 214; a detect APP module, performing 213; a receive service ID module, performing receiving signal 221; and a transmit service ID module for transmitting the signal under step 219. Still further, bearer resource command module 2200A for conveying EPV Bearer Resource Command signaling and a create PDP context request module, 2200AG, operative to convey GPRS Create PDP context Request signaling, are provided.

There is also provided a create bearer request module 220, performing Create Bearer request signaling under EPC and a initiate PDP context activation request module, for conveying GPRS Initiate PDP Context Activation Request signaling.

Finally, there is an uplink binding module 2401 and an IP traffic module 2280, performing steps 224 and 228, respectively.

In FIG. 6 the gateway is further shown, comprising a processing arrangement and interface means operative for setting up at least one dedicated bearer DB, or at least one secondary PDP contexts, SPC, the gateway 4 interacting with a terminal 1 and an application server 6, and for transmitting internet protocol packets between at least the terminal and the gateway. The processing arrangement 401 may comprise a processor 402 and a memory 404 and wherein said memory is containing instructions executable by said processor.

The processing arrangement may be operative to provide 209 a list of associations in or to the gateway, wherein each association comprises a service identity m, n and one or more applications p; q; set 202 up a default bearer or first PDP context between the terminal and the gateway; detect 217 at least one FT associated with the started application; or receive information 219 concerning at least one FT associated with the started application and the service identity associated with the application; create 216, in the gateway 4, for the service identity associated with the started application in question, a further association concerning at least the detected one or more FT's; set up 220 a DB/SPC for the service identity between terminal and gateway; a processing arrangement moreover being operative to bind 226 in the gateway, the FT further associated with the service identity to the DB/SPC.

The processing arrangement of the gateway may further be operative to being provisioned 201 a list of service identities, whereby each service identity is assigned a given policy; apply 218 the policy for the service identity of the application being started according to the provisioning 210; transmit 220 a create bearer request signal comprising at least the service identity to the terminal for setting up the DB/SPC.

The create bearer request signal 220 may moreover comprise a quality of service defined according to the service identity in the provisioning.

The processing arrangement of the gateway may moreover being operative to transmit 221 a message to the terminal or receiving 219 a message from the terminal comprising the service identity and the at least one detected FT associated with the application.

The processing arrangement of the gateway may moreover being operative to detect 215, 217 the at least one FT associated with the started application in the gateway, and wherein deep packet inspection or heuristic routines is applied for the detection.

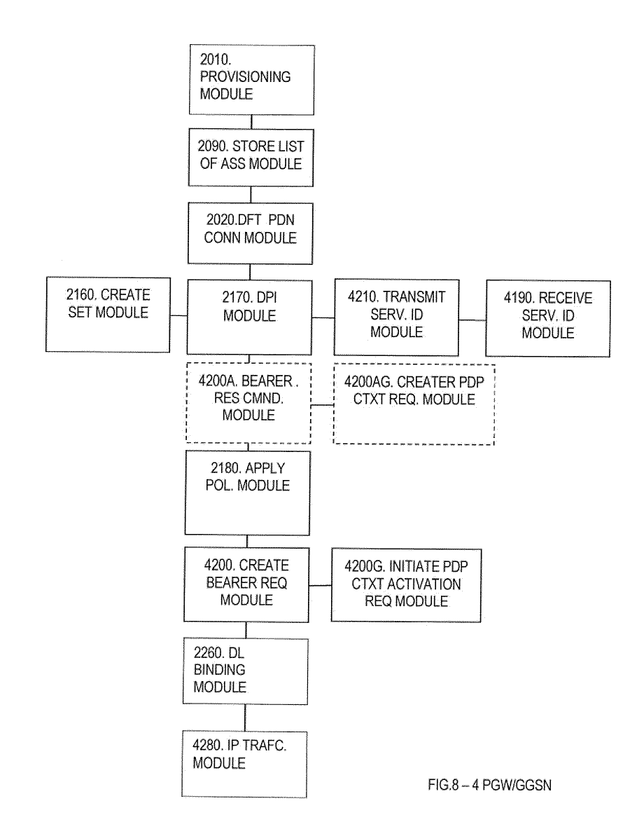

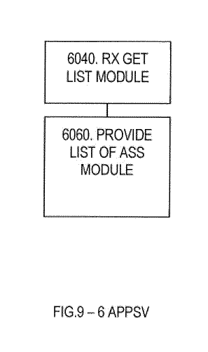

The gateway 4 may alternatively be implemented by means of the modules shown n FIG. 8, comprising a provisioning module 2010, for performing 201, a store list of associations module 2090 for performing 209; a default PDN connection module performing 202; a create set module 2160, performing 216; a deep packet inspection/heuristic's detection module performing step 217; a transmit service ID module 4210 performing transmitting signal 221; and a receive service ID module 4190 performing receiving signal transmitted under 219. Moreover, there is provided a bearer resource command module 4200A, conveying EPC Bearer Resource Command; a create PDP context request module for conveying GPRS Create PDP Context Request signaling. There is also provided an apply policy module 2180, performing 218; a create bearer request module 4200, performing EPC Create Bearer Request signaling; and an initiate PDP context activation request module GPRS performing Initiate PDP Context Activation request signaling. A downlink binding module 2260 performing 226 and am IP traffic module 4280, performing 228 IP traffic are also provided.

Finally in FIG. 6, there is provided an application server 6 comprising a processing means 601, operative to for assist setting up at least one dedicated bearer, DB, or at least one secondary PDP contexts, SPC, the application server interacting with a terminal 1 and a gateway 4, for transmitting internet protocol packets between one another.

The processing arrangement 601 of the application server comprises a processor 602 and a memory 604 and wherein said memory is containing instructions executable by said processor. The processing arrangement of the application server may be operative to transmit 206 a list of associations from the application server, wherein each association comprises a service identity m, n and one or more applications 1..p; 1..q; and provide 206; 208 a list of associations from the application server to the terminal;

The application server 6 may alternatively be arranged comprising a receive get list module 6040, carrying out step 204, and a provide list of association module 6060, performing the list shown and described according to step 206.

1. A method for setting up at least one dedicated bearer, (DB), or at least a secondary PDP context (SPC), in a system comprising a terminal, a gateway, and an application server for the method comprising:
setting up a default bearer or a first PDP context between the terminal and the gateway;
providing a list of associations from the application server to the terminal, and providing a list of associations in or to the gateway, wherein each association comprises a service identity and one or more applications;
starting an application;
detecting at least one or more five-tuples (FT) associated with the application;
creating, in both the terminal and the gateway, for the service identity associated with the stated application in question, a further association concerning at least the detected one or more FT;
setting up a DB/SPC for the service identity between terminal and gateway; and
binding, in the terminal and/or in the gateway, the FT further associated with the service identity to the DB/SPC.

2. The method of claim 1, moreover comprising the steps
provisioning a list of policies in the gateway, whereby each service identity is assigned a given policy;
applying the policy for the service identity of the application being started according to the provisioning;
transmitting a create bearer request signal comprising at least the service identity from the gateway to the terminal for setting up the DB/SPC.

3. The method of claim 2, wherein the create bearer request signal moreover comprises a quality of service defined according to a policy the service identity assigned in the provisioning.

4. A method for a terminal for assisting setting up at least one dedicated bearerl (DB), or at least one secondary PDP context SPC), the terminal interacting with a gateway and an application server, the method comprising:
receiving and storing a list of associations from the application server, wherein each association comprises a service identity and one or more applications, for instance upon transmitting a get list signal to the application server;
starting an application;
detecting at least one FT associated with the started application; or receive information concerning at least one FT associated with the started application and the service identity associated with the application;
creating for the service identity associated with the application in question, a further association concerning the at least one detected FT;
setting up a DB/SPC for the service identity between terminal and gateway; and
binding, the at least one FT further associated with the service identity to the dedicated bearer.

5. The method of claim 4, comprising the steps of
transmitting a message to the gateway or receiving a message from the gateway comprising the service identity and the at least one detected FT associated with the application.

6. The method of claim 4, further comprising the step of
detecting the at least one FT associated with the started application in the terminal.

7. A method for a gateway for setting up at least one dedicated bearer (DB), or at least one secondary PDP context (SPC), the gateway interacting with a terminal and an application server, the method comprising:
providing a list of associations in or to the gateway, wherein each association comprises a service identity (m, n) and one or more applications;
setting up a default bearer or first PDP context between the terminal and the gateway;
detecting at least one FT associated with the started application; or receiving information concerning at least one FT associated with the started application and the service identity associated with the application;
creating, in the gateway, for the service identity associated with the started application in question, a further association concerning at least the detected one or more FT's;
setting up a DB/SPC for the service identity between terminal and gateway; and
binding in the gateway, the FT further associated with the service identity to the DB/SPC.

8. The method of claim 7, comprising the steps of the gateway
being provisioned a list of policies, whereby each service identity is assigned a given policy;
applying the policy for the service identity of the application being started according to the provisioning;
transmitting a create bearer request signal comprising at least the service identity to the terminal for setting up the DB/SPC.

9. The method of claim 7, wherein the create bearer request signal moreover comprises a quality of service defined according to the service identity in the provisioning.

10. The method of claim 7, comprising the steps of
transmitting a message to the terminal or receiving a message from the terminal comprising the service identity and the at least one detected FT associated with the application.

11. The method of claim 7, comprising the step of
detecting the at least one FT associated with the started application in the gateway, and wherein deep packet inspection or heuristic routines is applied for the detection.

12. A method for an application server, for assisting setting up at least one dedicated bearer (DB) or at least one secondary PDP context (SPC) the application server interacting with a terminal and a gateway, for transmitting Internet protocol packets between one another, the method comprising the steps
transmitting a list of associations from the application server, wherein each association comprises a service identity and one or more applications;
providing a list of associations from the application server to the terminal.

13. A computer program product for carrying out any of the methods of claim 1.

14. A terminal comprising a processing arrangement and interface means operative to assisting setting up assisting at least one dedicated bearer (DB) or at least one secondary PDP context (SPC) the terminal interacting with a gateway and an application server, and for transmitting internet protocol packets between at least the terminal and the gateway, wherein the processing arrangement is operative to:
receive and store a list of associations from the application server, wherein each association comprises a service identity and one or more applications, for instance upon transmitting a get list signal to the application server;
start an application,
detect at least one FT associated with the started application; or receive information concerning at least one FT associated with the started application and the service identity associated with the application;
create, for the service identity associated with the application in question, a further association concerning the at least one detected FT;
set up a DB/SPC for the service identity between terminal and gateway; and
bind, the at least one FT further associated with the service identity to the dedicated bearer.

15. The terminal of claim 14, further being operative to
transmit a message to the gateway or receiving a message from the gateway comprising the service identity and the at least one detected FT associated with the application.

16. The terminal of claim 14, further being operative to
detecting the at least one FT associated with the started application.

17. The terminal of claim 14, wherein the processing arrangement comprises a processor and a memory and wherein said memory is containing instructions executable by said processor.

18. A gateway comprising a processing arrangement and interface means operative for setting up at least one dedicated bearer DB, or at least one secondary PDP contexts (SPC) the gateway interacting with a terminal and an application server, and for transmitting internet protocol packets between at least the terminal and the gateway, wherein the processing arrangement is operative to:
provide a list of associations in or to the gateway, wherein each association comprises a service identity and one or more applications;
set up a default bearer or first PDP context between the terminal and the gateway;
detect at least one FT associated with the started application; or receive information concerning at least one FT associated with the started application and the service identity associated with the application;
create, in the gateway, for the service identity associated with the started application in question, a further association concerning at least the detected one or more FT's;
set up a DB/SPC for the service identity between terminal and gateway; and
bind in the gateway, the FT further associated with the service identity to the DB/SPC.

19. The gateway of claim 18, wherein the processing arrangement is operative to
being provisioned a list of service identities, whereby each service identity is assigned a given policy;
apply the policy for the service identity of the application being started according to the provisioning;
transmit a create bearer request signal comprising at least the service identity to the terminal for setting up the DB/SPC.

20. The gateway of claim 18, wherein the create bearer request signal moreover comprises a quality of service defined according to the service identity in the provisioning.

21. The gateway of claim 18, the processing arrangement moreover being operative to
transmit a message to the terminal or receiving a message from the terminal comprising the service identity and the at least one detected FT associated with the application.

22. The gateway of claim 18, the processing arrangement moreover being operative to
detect the at least one FT associated with the started application in the gateway, and wherein deep packet inspection or heuristic routines is applied for the detection.

23. The gateway of claim 1, wherein the processing arrangement comprises a processor and a memory and wherein said memory is containing instructions executable by said processor.

24. An application server comprising a processing arrangement comprising or more processors, operative to assist setting up at least one dedicated bearer (DB), or at least one secondary PDP con-texts (SPC), the application server interacting with a terminal and a gateway the processing arrangement being operative to:
transmit a list of associations from the application server, wherein each association comprises a service identity and one or more applications; and
provide a list of associations from the application server to the terminal.

25. The application server of claim 24, wherein the processing arrangement comprises a processor and a memory and wherein said memory is containing instructions executable by said processor.
